(19) United States
(12) Patent Application Publication
(10) Pub. No.: US 2026/0168825 A1
(43) Pub. Date: Jun. 18, 2026

(54) SENSOR AND METHOD FOR ADJUSTING LEAD WIRE INTERVALS THEREOF

(71) Applicant: Proterial, Ltd., Tokyo (JP)

(72) Inventors: Hiroshi Yamada, Tokyo (JP); Teruyoshi Shirota, Tokyo (JP); Tomoaki Suzuki, Tokyo (JP); Kazuhiko Tomita, Tokyo (JP); Takashi Onimoto, Tokyo (JP)

(21) Appl. No.: 19/412,009

(22) Filed: Dec. 8, 2025

(30) Foreign Application Priority Data
Dec. 12, 2024 (JP) 2024-217515

(51) Int. Cl. G01D 11/00

(52) U.S. Cl. CPC G01D 11/00

(57) ABSTRACT

Provided is a method for adjusting lead wire intervals of a sensor, the sensor including a sensing portion, and four or more aligned lead wires extending in a common direction from the sensing portion. The lead wire intervals is intervals between the four or more aligned lead wires. Two outer-side lead wires situated at outermost positions among the four or more aligned lead wires are bent outward at A-bend portions and inward at B-bend portions situated on a tip side relative to the A-bend portions. Two inner-side lead wires situated on an inner side of the two outer-side lead wires among the four or more aligned lead wires are bent outward at C-bend portions and inward at D-bend portions situated on the tip side relative to the C-bend portions.

### CROSS-REFERENCE TO RELATED APPLICATIONS

This application claims the benefit of Japanese Patent Application No. 2024-217515 filed on Dec. 12, 2024 with the Japan Patent Office, the entire disclosure of which is incorporated herein by reference.

### BACKGROUND

The present disclosure relates to a sensor, and a method for adjusting intervals of lead wires (lead wire intervals) of the sensor.

In recent years, from a fail-safe perspective, redundancy is actively implemented in vehicles. Japanese Unexamined Patent Application Publication No. 2023-041823 discloses a composite cable capable of redundancy. This composite cable includes two sensors and four insulated wires. Each sensor is coupled to two of the four insulated wires.

### SUMMARY

As one way of redundancy, there is a method in which a sensor itself is made redundant. This sensor includes two sensing elements installed therein. Even if one of the sensing elements is damaged, the other one works as a backup. In a case where the sensor includes two or more sensing elements installed therein, the number of lead wires included in the sensor increases, which decreases the intervals between the lead wires. This makes it difficult to weld electrodes or power conductors to the lead wires.

In one aspect of the present disclosure, it is desirable to provide a sensor capable of increasing intervals between four or more lead wires, and a method for adjusting lead wire intervals of the sensor.

One aspect of the present disclosure is a method for adjusting lead wire intervals of a sensor, the sensor including a sensing portion, and four or more aligned lead wires extending in a common direction from the sensing portion, and the lead wire intervals being intervals between the four or more aligned lead wires of the sensor. The method includes bending two outer-side lead wires situated at outermost positions among the four or more aligned lead wires outward at A-bend portions and inward at B-bend portions which are situated on a tip side of the outer-side lead wires relative to the A-bend portions. The method includes bending two inner-side lead wires situated on an inner side of the two outer-side lead wires among the four or more aligned lead wires outward at C-bend portions and inward at D-bend portions which are situated on the tip side of the inner-side lead wires relative to the C-bend portions.

According to the method for adjusting lead wire intervals of the sensor which is one aspect of the present disclosure, it is possible to increase intervals between four or more lead wires.

Another aspect of the present disclosure is a sensor including a sensing portion and four or more aligned lead wires extending in a common direction from the sensing portion. Among the four or more aligned lead wires, two outer-side lead wires situated at the outermost positions are bent outward at the A-bend portions and bent inward at the B-bend portions which are situated on the tip side of the outer-side lead wires relative to the A-bend portions. Among the four or more aligned lead wires, two inner-side lead wires situated in the inner side of the outer-side lead wires are bent outward at the C-bend portions and bent inward at the D-bend portions which are situated on the tip side of the inner-side lead wires relative to the C-bend portions.

The sensor in another aspect of the present disclosure described above is capable of increasing intervals between four or more lead wires.

### BRIEF DESCRIPTION OF THE DRAWINGS

Example embodiments of the present disclosure will be described hereinafter with reference to the accompanying drawings, in which:

FIG. 1 is a plan view showing a configuration of a sensor;

FIG. 2 is a plan view showing a configuration of an unprocessed sensor;

FIG. 3 is an explanatory drawing showing a punching process;

FIG. 4A is a plan view showing a configuration of the sensor after the punching process;

FIG. 4B is an orthogonal cross-sectional view of a lead wire taken along a line IVB-IVB in FIG. 2;

FIG. 4C is an orthogonal cross-sectional view of the lead wire taken along a line IVC-IVC in FIG. 4A;

FIG. 5 is an explanatory drawing showing an operation of bending lead wires at A-bend portions;

FIG. 6 is an explanatory drawing showing an operation of bending lead wires at C-bend portions;

FIG. 7 is an explanatory drawing showing an operation of bending the lead wires at D-bend portions;

FIG. 8 is an explanatory drawing showing an operation of bending the lead wires at the D-bend portions;

FIG. 9 is an explanatory drawing showing an operation of bending the lead wire at the D-bend portions;

FIG. 10 is an explanatory drawing showing an operation of bending the lead wires at B-bend portions; and

FIG. 11 is an explanatory drawing showing a state in which an insulated wire is welded to each of four lead wires of the sensor.

### DETAILED DESCRIPTION OF EXEMPLARY EMBODIMENTS

### First Embodiment

### 1. Configuration of Sensor 1

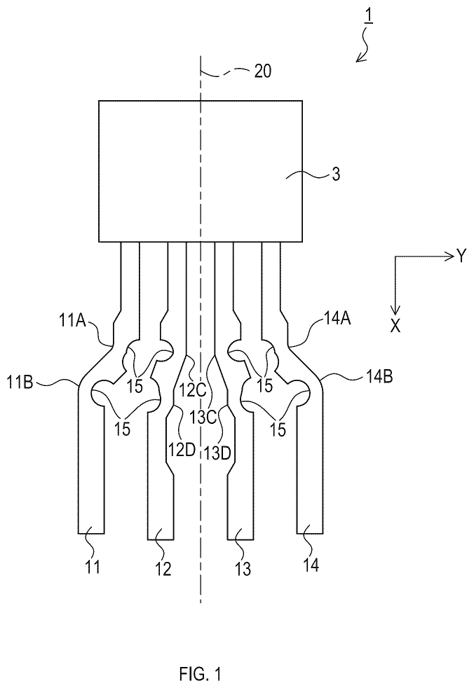

A configuration of a sensor 1 will be explained with reference to FIG. 1. The sensor 1 is an ABS (anti-lock braking system) sensor, for example. The sensor 1 includes a sensing portion 3, and four lead wires 11, 12, 13, 14. The sensing portion 3 includes two sensing elements and a capacitor installed therein. The sensing element is a magnetism detecting element, for example.

The four lead wires 11, 12, 13, 14 extend in a common direction from the sensing portion 3. The direction in which the four lead wires 11, 12, 13, 14 extend is referred to as an extending direction X. The four lead wires 11, 12, 13, 14 are aligned along a direction Y in this order. The direction Y is orthogonal to the extending direction X. The direction Y is also orthogonal to thickness directions of the lead wires 11, 12, 13, 14.

The lead wires 11, 14 are two lead wires situated at outermost positions among the four lead wires 11, 12, 13, 14. The “outer” sides refer to sides away from a reference line 20. The reference line 20 is an imaginary straight line that passes between the lead wire 12 and the lead wire 13 and extends in the extending direction X. The reference line 20 and the four lead wires 11, 12, 13, 14 are aligned along the direction Y. The reference line 20 is a straight line that equally divides four or more lead wires into two. The lead wires 11, 14 correspond to outer-side lead wires.

The lead wires 12, 13 are two lead wires situated on an inner side of the lead wires 11, 14. The “inner” side refers to a side close to the reference line 20. The lead wires 12, 13 correspond to inner-side lead wires.

The lead wire 11 is bent outward at an A-bend portion 11A and bent inward at a B-bend portion 11B. Being bent outward means being bent so that a tip of the lead wire 11 is moved to the outer side. Being bent inward means being bent so that the tip of the lead wire 11 is moved to the inner side.

The A-bend portion 11A is situated away from the sensing portion 3. The distance between the A-bend portion 11A and the sensing portion 3 is, for example, greater than or equal to 1.5 mm and less than or equal to 2.5 mm. The B-bend portion 11B is situated on a tip side relative to the A-bend portion 11A. The tip side is a side of the tip of the lead wire 11.

A portion of the lead wire 11 situated on a root side relative to the A-bend portion 11A extends parallel to the extending direction X. The root side is a side opposite to the tip side and closer to the sensing portion 3. A portion of the lead wire 11 situated between the A-bend portion 11A and the B-bend portion 11B extends in a direction that is inclined with respect to the extending direction X. This inclined direction is a direction which, along the lead wire 11, extends outward toward the tip side of the lead wire 11. A portion of the lead wire 11 situated on the tip side relative to the B-bend portion 11B extends parallel to the extending direction X.

The lead wire 14 is bent outward at an A-bend portion 14A and bent inward at a B-bend portion 14B. The A-bend portion 14A is situated away from the sensing portion 3. The distance between the A-bend portion 14A and the sensing portion 3 is, for example, greater than or equal to 1.5 mm and less than or equal to 2.5 mm. The B-bend portion 14B is situated on a tip side relative to the A-bend portion 14A. The tip side is a side of the tip of the lead wire 14.

A portion of the lead wire 14 situated on the root side relative to the A-bend portion 14A extends parallel to the extending direction X. A portion of the lead wire 14 situated between the A-bend portion 14A and the B-bend portion 14B extends in a direction that is inclined with respect to the extending direction X. This inclined direction is a direction which, along the lead wire 14, extends outward toward the tip side of the lead wire 14. A portion of the lead wire 14 situated on the tip side relative to the B-bend portion 14B extends parallel to the extending direction X.

The lead wire 12 is bent outward at a C-bend portion 12C and bent inward at a D-bend portion 12D. The C-bend portion 12C is situated away from the sensing portion 3. The distance between the C-bend portion 12C and the sensing portion 3 is, for example, greater than or equal to 1.5 mm and less than or equal to 2.5 mm. The D-bend portion 12D is situated on a tip side relative to the C-bend portion 12C. The tip side is a side of the tip of the lead wire 12.

A portion of the lead wire 12 situated on the root side relative to the C-bend portion 12C extends parallel to the extending direction X. A portion of the lead wire 12 situated between the C-bend portion 12C and the D-bend portion 12D extends in a direction that is inclined with respect to the extending direction X. This inclined direction is a direction which, along the lead wire 12, extends outward toward the tip side of the lead wire 12. A portion of the lead wire 12 situated on the tip side relative to the D-bend portion 12D extends parallel to the extending direction X.

The lead wire 13 is bent outward at a C-bend portion 13C and bent inward at a D-bend portion 13D. The C-bend portion 13C is situated away from the sensing portion 3. The distance between the C-bend portion 13C and the sensing portion 3 is, for example, greater than or equal to 1.5 mm and less than or equal to 2.5 mm. The D-bend portion 13D is situated on a tip side relative to the C-bend portion 13C. The tip side is a side of the tip of the lead wire 13.

A portion of the lead wire 13 situated on the root side relative to the C-bend portion 13C extends parallel to the extending direction X. A portion of the lead wire 13 situated between the C-bend portion 13C and the D-bend portion 13D extends in a direction that is inclined with respect to the extending direction X. This inclined direction is a direction which, along the lead wire 13, extends outward toward the tip side of the lead wire 13. A portion of the lead wire 13 situated on the tip side relative to the D-bend portion 13D extends parallel to the extending direction X.

Bending angles at the C-bend portions 12C, 13C and D-bend portions 12D, 13D are smaller than bending angles at the A-bend portions 11A, 14A and B-bend portions 11B, 14B. The bending angle in a case where the lead wire is not bent at all is zero degrees. The bending angle in a case where the lead wire is bent at a right angle is 90 degrees. The lead wires 11, 12, 13, 14 each include on their root sides a portion the width W of which in the direction Y is narrower than other portions. This portion with the narrower width W is not bent and extends along the extending direction X.

The lead wire 11 includes a recessed portion 15 each at the A-bend portion 11A and the B-bend portion 11B on a side facing the lead wire 12. The recessed portion 15 is a portion that is depressed when viewed from the thickness directions of the lead wires 11, 12, 13, 14 (that is, directions orthogonal to both the extending direction X and the direction Y). As a result, the width W of the lead wire 11 in the direction Y is made narrower at the A-bend portion 11A and the B-bend portion 11B than their surrounding area. The surrounding area is a portion of the lead wire 11 situated between the A-bend portion 11A and the B-bend portion 11B. When viewed from the thickness directions of the lead wires 11, 12, 13, 14, the shape of the recessed portion 15 is an arc, for example.

The lead wires 11, 12 correspond to two adjacent lead wires. A portion of the lead wire 11 where the recessed portion 15 is formed is a portion facing a counterpart lead wire (that is the lead wire 12) of the two adjacent lead wires. The counterpart lead wire refers to the other one of the two adjacent lead wires.

The lead wire 14 includes the recessed portion 15 each at the A-bend portion 14A and the B-bend portion 14B on a side facing the lead wire 13. The recessed portion 15 is a portion that is depressed when viewed from the thickness directions of the lead wires 11, 12, 13, 14. As a result, the width W of the lead wire 14 in the direction Y is made narrower at the A-bend portion 14A and the B-bend portion 14B than their surrounding area. The surrounding area is a portion of the lead wire 14 situated between the A-bend portion 14A and the B-bend portion 14B. When viewed from the thickness directions of the lead wires 11, 12, 13, 14, the shape of the recessed portion 15 is an arc, for example.

The lead wires 13, 14 correspond to two adjacent lead wires. A portion of the lead wire 14 where the recessed portion 15 is formed is a portion facing the counterpart lead wire (that is the lead wire 13) of the two adjacent lead wires.

The lead wire 12 includes the recessed portion 15 each at the C-bend portion 12C and the D-bend portion 12D on a side facing the lead wire 11. The recessed portion 15 is a portion that is depressed when viewed from the thickness directions of the lead wires 11, 12, 13, 14. As a result, the width W of the lead wire 12 in the direction Y is made narrower at the C-bend portion 12C and the D-bend portion 12D than their surrounding area. The surrounding area is a portion of the lead wire 12 situated between the C-bend portion 12C and the D-bend portion 12D. When viewed from the thickness directions of the lead wires 11, 12, 13, 14, the shape of the recessed portion 15 is an arc, for example.

The lead wires 11, 12 correspond to two adjacent lead wires. A portion of the lead wire 12 where the recessed portion 15 is formed is a portion facing the counterpart lead wire (that is the lead wire 11) of the two adjacent lead wires.

The lead wire 13 includes the recessed portion 15 each at the C-bend portion 13C and the D-bend portion 13D on a side facing the lead wire 14. The recessed portion 15 is a portion that is depressed when viewed from the thickness directions of the lead wires 11, 12, 13, 14. As a result, the width W of the lead wire 13 in the direction Y is made narrower at the C-bend portion 13C and the D-bend portion 13D than their surrounding area. The surrounding area is a portion of the lead wire 13 situated between the C-bend portion 13C and the D-bend portion 13D. When viewed from the thickness directions of the lead wires 11, 12, 13, 14, the shape of the recessed portion 15 is an arc, for example.

The lead wires 13, 14 correspond to two adjacent lead wires. A portion of the lead wire 13 where the recessed portion 15 is formed is a portion facing the counterpart lead wire (that is the lead wire 14) of the two adjacent lead wires.

### 2. Configuration of Unprocessed Sensor 101

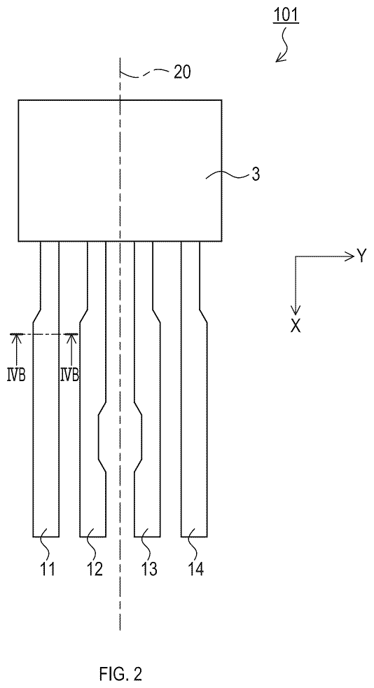

The sensor 1 is manufactured by using an unprocessed sensor 101 shown in FIG. 2. Manufacturing the sensor 1 by using the unprocessed sensor 101 corresponds to adjusting intervals between the lead wires 11, 12, 13, 14. A configuration of the unprocessed sensor 101 is basically the same as the configuration of the sensor 1. However, the four lead wires 11, 12, 13, 14 are not bent and they extend parallel to the extending direction X over the entire length. Thus, on the tip side, the interval between the lead wire 11 and the lead wire 12, the interval between the lead wire 12 and the lead wire 13, and the interval between the lead wire 13 and the lead wire 14 are narrower in the unprocessed sensor 101 than in the sensor 1. In addition, no recessed portions 15 are formed in the lead wires 11, 12, 13, 14 of the unprocessed sensor 101.

### 3. Method for Adjusting Lead Wire Intervals of Sensor 1

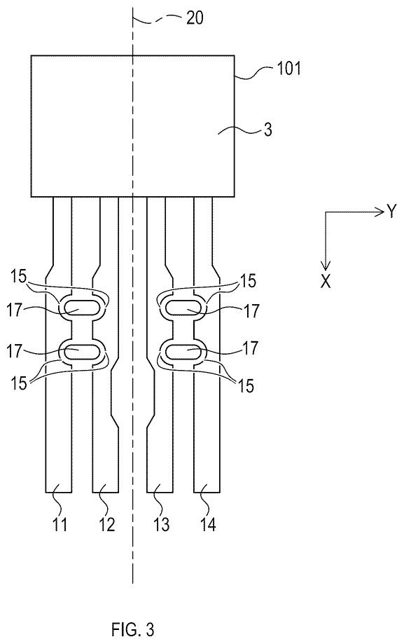

A method for adjusting lead wire intervals of the sensor 1 will be explained with reference to FIG. 3 to FIG. 10. The intervals between the lead wires 11, 12, 13, 14 are adjusted in the method for adjusting the lead wire intervals of the sensor 1.

### (3-1) Punching Process

As shown in FIG. 3, a process of narrowing the widths W in the direction Y is performed on the lead wires 11, 14 of the unprocessed sensor 101 at portions that later become the A-bend portions 11A, 14A and the B-bend portions 11B, 14B. This process includes punching a portion of the lead wires 11, 14 with a punch 17 and forming the recessed portions 15 (hereinafter referred to as “punching process”).

The portion to be punched with the punch 17 on each of the two adjacent lead wires faces the counterpart lead wire. For example, a portion of the lead wire 11 which faces the adjacent lead wire 12 is punched. For example, a portion of the lead wire 14 which faces the adjacent lead wire 13 is punched.

In addition, a process of narrowing the width W in the direction Y is performed on the lead wires 12, 13 of the unprocessed sensor 101 at portions that later become the C-bend portions 12C, 13C and the D-bend portions 12D, 13D. This process is the punching process that includes punching a portion of the lead wires 12, 13 with the punch 17 and forming the recessed portion 15.

The portion to be punched with the punch 17 on each of the two adjacent lead wires faces the counterpart lead wire. For example, a portion of the lead wire 12 which faces the adjacent lead wire 11 is punched. For example, a portion of the lead wire 13 which faces the adjacent lead wire 14 is punched.

When performing the punching process, the recessed portion 15 on the lead wire 11 and the recessed portion 15 on the lead wire 12 are simultaneously formed by using the punch 17. Similarly, the recessed portion 15 on the lead wire 13 and the recessed portion 15 on the lead wire 14 are simultaneously formed by using the punch 17. These simultaneously formed recessed portions 15 have the same size. These simultaneously formed recessed portions 15 have symmetric shapes.

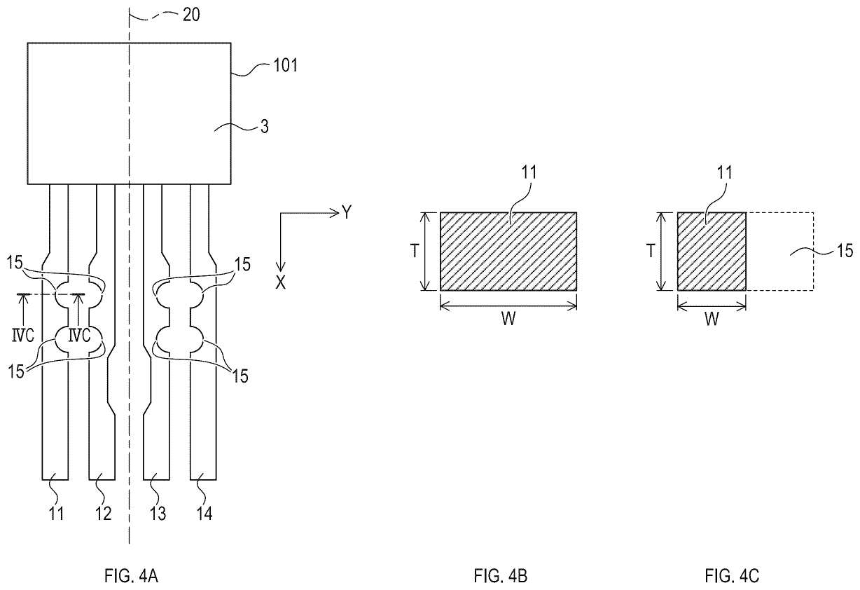

As a result of the punching process, as shown in FIG. 4A, the recessed portions 15 are formed at portions of the lead wires 11, 12, 13, 14 that later become the A-bend portions 11A, 14A, the B-bend portions 11B, 14B, the C-bend portions 12C, 13C, and the D-bend portions 12D, 13D. The widths W in the direction Y at these portions are consequently narrower than their surrounding areas.

FIG. 4B shows an orthogonal cross section of a portion of the lead wire 11 that later becomes the A-bend portion 11A before the punching process is performed. The orthogonal cross section is a cross section of the lead wire 11 that is orthogonal to the longitudinal direction of the lead wire 11. The orthogonal cross section shown in FIG. 4B is taken along a line IVB-IVB in FIG. 2. The shape of the orthogonal cross section shown in FIG. 4B is a rectangle having its longer sides parallel to the direction Y. The length of the longer sides of this rectangle is the width W. The length of shorter sides of this rectangle is a thickness T of the lead wire 11.

FIG. 4C shows an orthogonal cross section of a portion of the lead wire 11 that later becomes the A-bend portion 11A after the punching process is performed. The orthogonal cross section shown in FIG. 4C is taken along a line IVC-IVC in FIG. 4A. When compared with the shape of the orthogonal cross section shown in FIG. 4B, the width W in the direction Y of the orthogonal cross section shown in FIG. 4C is reduced by an amount corresponding to the recessed portion 15. In the orthogonal cross section shown in FIG. 4C, it is preferable that the width W is smaller than the thickness T of the lead wire 11.

Similarly, the widths W in the direction Y of the portions that later become the A-bend portion 14A, the B-bend portions 11B, 14B, the C-bend portions 12C, 13C, and the D-bend portions 12D, 13D are also reduced by an amount corresponding to the recessed portion 15 due to the punching process. The same punch 17 is used to punch the lead wires 11, 12, 13, 14.

### (3-2) Operation of Bending Lead Wires 11, 14 at A-Bend Portions 11A, 14A

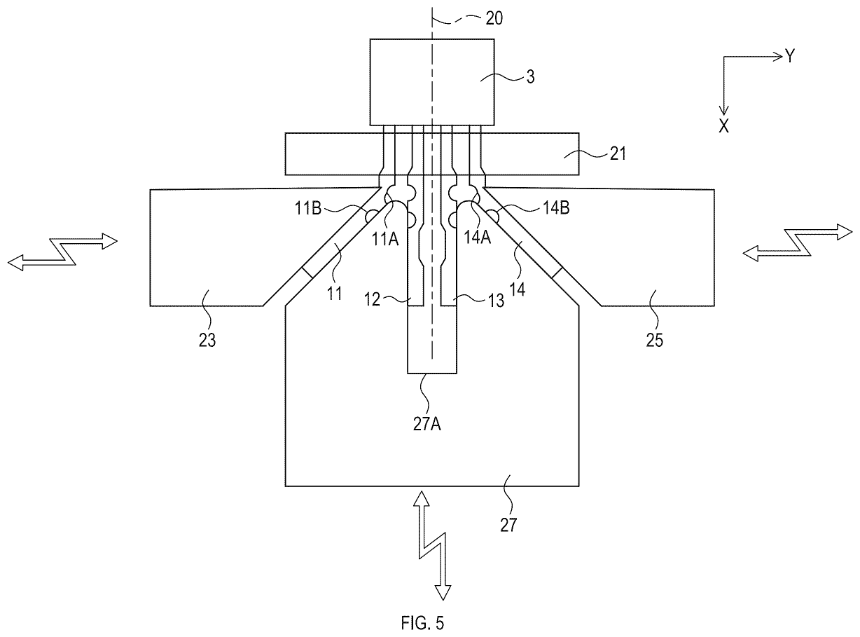

Next, an operation of bending the lead wires 11, 14 at the A-bend portions 11A, 14A is performed. In this operation, a hold-down member 21, guides 23, 25, and a pusher 27 shown in FIG. 5 are used.

The hold-down member 21 is for fixing the roots of the lead wires 11, 12, 13, 14 so that they do not move. The roots of the lead wires 11, 12, 13, 14 refer to a portion of the lead wire 11 that is situated on the root side relative to the portion that later becomes the A-bend portion 11A, a portion of the lead wire 14 that is situated on the root side relative to the portion that later becomes the A-bend portion 14A, a portion of the lead wire 12 that is situated on the root side relative to the portion that later becomes the C-bend portion 12C, and a portion of the lead wire 13 that is situated on the root side relative to the portion that later becomes the C-bend portion 13C.

The guide 23 is arranged outside of the lead wire 11. In an initial state, there is a clearance between the guide 23 and the lead wire 11. The guide 25 is arranged outside of the lead wire 14. In the initial state, there is a clearance between the guide 25 and the lead wire 14.

In the initial state, the pusher 27 is arranged further in the extending direction X than the lead wires 11, 12, 13, 14 are. The basic shape of portions of the pusher 27 that face the lead wires 11, 12, 13, 14 is a tapered shape. However, there is a recessed portion 27A formed at the center of the pusher 27.

The pusher 27 moves toward the lead wires 11, 12, 13, 14. The guides 23, 25 each move inward. At this time, the lead wires 12, 13 are housed in the recessed portion 27A and therefore do not receive a bending stress from the pusher 27. The pusher 27 applies an outward bending stress to the lead wires 11, 14. The lead wire 11 is bent outward at the A-bend portion 11A. The lead wire 14 is bent outward at the A-bend portion 14A.

When the lead wire 11 is bent at the A-bend portion 11A to a given angle, the lead wire 11 comes into contact with the guide 23 and cannot be bent any further. When the lead wire 14 is bent at the A-bend portion 14A to a given angle, the lead wire 14 comes into contact with the guide 25 and cannot be bent any further. The given angle is an angle corresponding to the pitch of the lead wires 11, 12, 13, and 14.

### (3-3) Operation of Bending Lead Wires 12, 13 at C-Bend Portions 12C, 13C

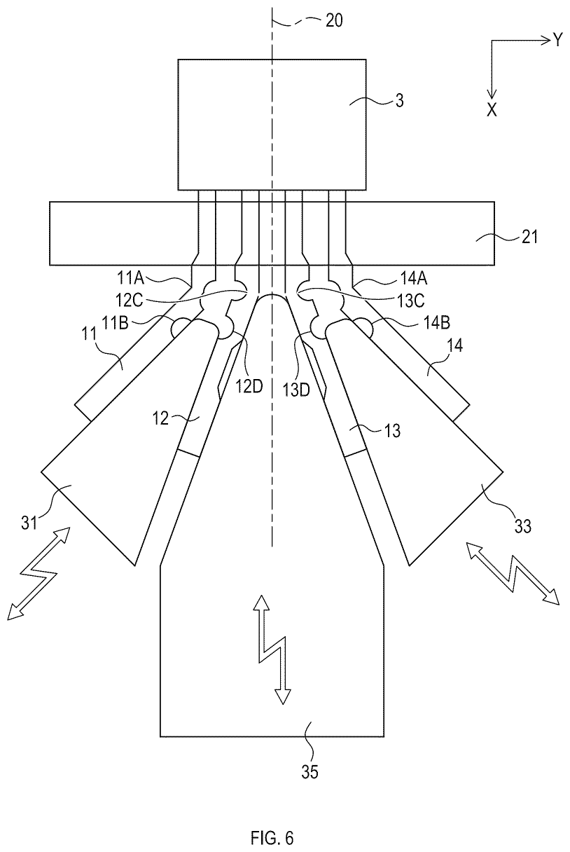

Next, an operation of bending the lead wires 12, 13 at the C-bend portions 12C, 13C is performed. In this operation, the hold-down member 21, guides 31, 33, and a pusher 35 shown in FIG. 6 are used. The hold-down member 21 is the same as the one used in the operation of bending the lead wires 11, 14 at the A-bend portions 11A, 14A.

The guides 31, 33 each have a tapered shape. The guide 31 is inserted between the lead wire 11 and the lead wire 12. The guide 33 is inserted between the lead wire 13 and the lead wire 14. In the initial state, there is a clearance between the guide 31 and the lead wire 12. In the initial state, there is also a clearance between the guide 33 and the lead wire 13.

In the initial state, the pusher 35 is arranged further in the extending direction X than the lead wires 11, 12, 13, 14 are. The shape of a portion of the pusher 35 that faces the lead wires 11, 12, 13, 14 is a tapered shape.

The pusher 35 is inserted between the lead wire 12 and the lead wire 13. The guides 31, 33 each move in a direction where their leading ends are pointing. At this time, the pusher 35 applies an outward bending stress to the lead wires 12, 13. The lead wire 12 is bent outward at the C-bend portion 12C. The lead wire 13 is bent outward at the C-bend portion 13C.

When the lead wire 12 is bent at the C-bend portion 12C to a given angle, the lead wire 12 comes into contact with the guide 31 and cannot be bent any further. When the lead wire 13 is bent at the C-bend portion 13C to a given angle, the lead wire 13 comes into contact with the guide 33 and cannot be bent any further.

### (3-4) Operation of Bending Lead Wires 12, 13 at D-Bend Portions 12D, 13D

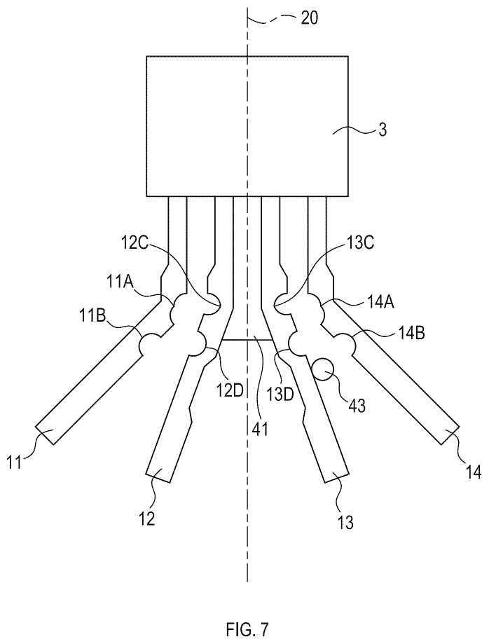

Next, an operation of bending the lead wires 12, 13 at the D-bend portions 12D, 13D is performed. In this operation, a guide 41, and pushers 43, 45 shown in FIG. 7 to FIG. 9 are used. The guide 41 is inserted between the lead wire 12 and the lead wire 13. The guide 41 comes into contact with portions of the lead wires 12, 13 that are situated on the root side relative to portions of the lead wires 12, 13 that later become the D-bend portions 12D, 13D.

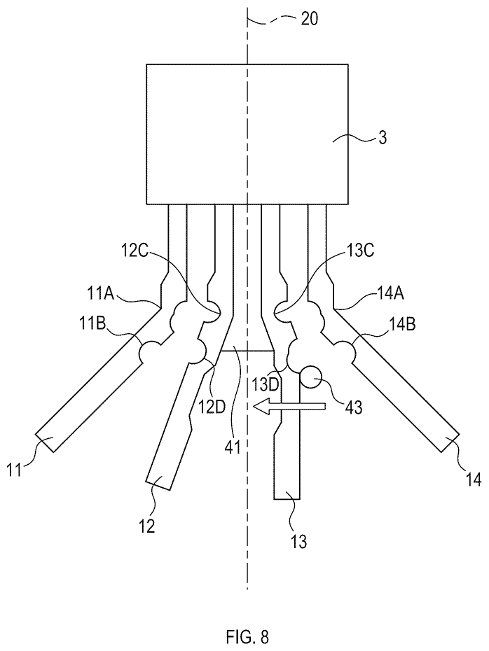

As shown in FIG. 7 and FIG. 8, the pusher 43 applies an inward bending stress to a portion of the lead wire 13 that is situated on the tip side relative to a portion of the lead wire 13 that later becomes the D-bend portion 13D. The lead wire 13 is bent inward at the D-bend portion 13D.

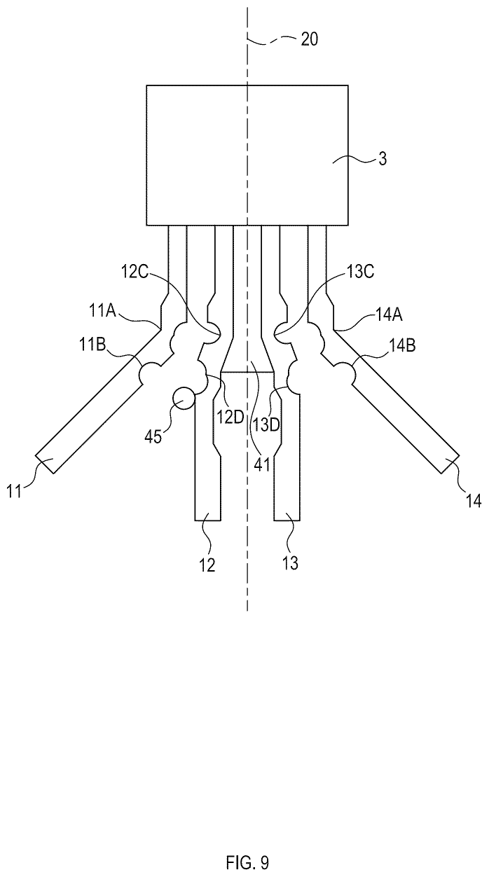

As shown in FIG. 9, the pusher 45 applies an inward bending stress to a portion of the lead wire 12 that is situated on the tip side relative to a portion of the lead wire 12 that later becomes the D-bend portion 12D. The lead wire 12 is bent inward at the D-bend portion 12D.

(3-5) Operation of Bending Lead Wires 11, 14 at B-Bend portions 11B, 14B

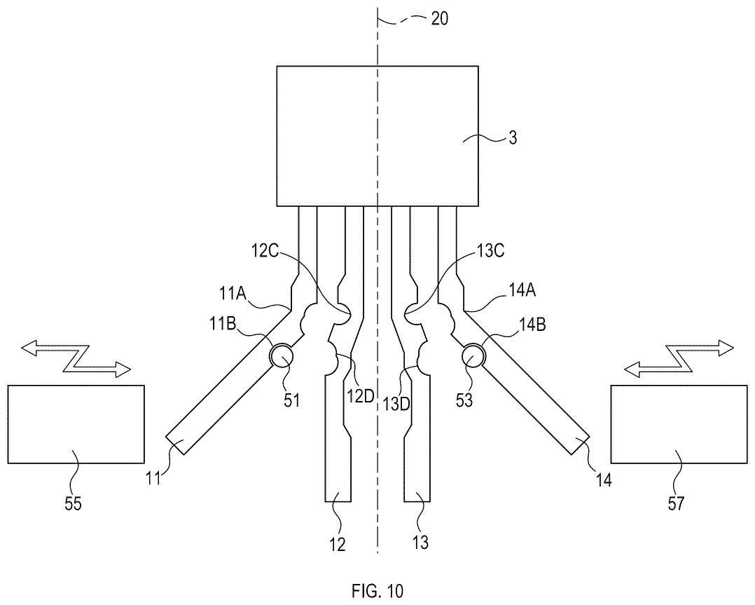

Next, an operation of bending the lead wires 11, 14 at the B-bend portion 11B, 14B is performed. In this operation, guides 51, 53, and pushers 55, 57 shown in FIG. 10 are used.

The guide 51 comes into contact with a portion of the lead wire 11 that later becomes the B-bend portion 11B from inside and supports the contacted portion so that the contacted portion does not move. The guide 53 comes into contact with a portion of the lead wire 14 that later becomes the B-bend portion 14B from inside and supports the contacted portion so that the contacted portion does not move.

The pusher 55 applies an inward bending stress to a portion of the lead wire 11 that is situated on the tip side relative to a portion of the lead wire 11 that later becomes the B-bend portion 11B. The lead wire 11 is bent inward at the B-bend portion 11B. The pusher 57 applies an inward bending stress to a portion of the lead wire 14 that is situated on the tip side relative to a portion of the lead wire 14 that later becomes the B-bend portion 14B. The lead wire 14 is bent inward at the B-bend portion 14B. According to the process and operations mentioned above, portions of the lead wires 11, 12, 13, 14 that are situated on the tip side relative to the B-bend portions 11B, 14B and the D-bend portions 12D, 13D extend parallel to the extending direction X, and the sensor 1 is thus manufactured.

### 4. Effects of Sensor 1 and Method for Adjusting Lead Wire Intervals of Sensor 1

(1A) The sensor 1 includes the A-bend portions 11A, 14A, the B-bend portions 11B, 14B, the C-bend portions 12C, 13C, and the D-bend portions 12D, 13D. Therefore, the sensor 1 has wider intervals between the lead wire 11 and the lead wire 12, between the lead wire 12 and the lead wire 13, and between the lead wire 13 and the lead wire 14 on the tip side than the unprocessed sensor 101 does. In the sensor 1, the intervals between the lead wire 11 and the lead wire 12, between the lead wire 12 and the lead wire 13, and between the lead wire 13 and the lead wire 14 on the tip side may be entirely the same, partially the same, or entirely different from each other. These intervals are greater than or equal to 1.5 mm and less than or equal to 3.5 mm, for example.

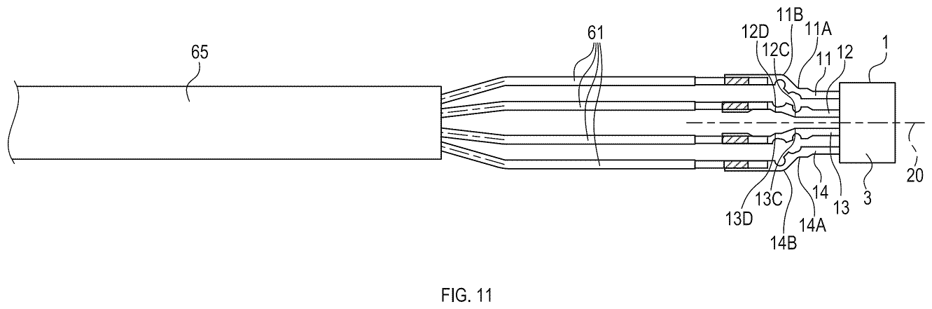

As a result, as shown in FIG. 11, a conductor of an insulated wire 61 can be easily welded to each of the lead wires 11, 12, 13, 14. For example, insulated wires 61 are drawn out from a single composite cable 65.

Conductors of the insulated wires 61 can be welded at a portion of the lead wire 11 situated on the tip side relative to the B-bend portion 11B, a portion of the lead wire 14 situated on the tip side relative to the B-bend portion 14B, a portion of the lead wire 12 situated on the tip side relative to the D-bend portion 12D, and a portion of the lead wire 13 situated on the tip side relative to the D-bend portion 13D. In this case, it is much easier to weld the conductors of the insulated wires 61 to the lead wires.
(1B) When manufacturing the sensor 1, before bending the lead wires at the A-bend portions 11A, 14A, the B-bend portions 11B, 14B, the C-bend portions 12C, 13C, and the D-bend portions 12D, 13D, the process of narrowing the widths W in the direction Y at these bend portions is performed.

Thus, when forming the A-bend portions 11A, 14A, the B-bend portions 11B, 14B, the C-bend portions 12C, 13C, and the D-bend portions 12D, 13D by the operations of bending, it is possible to inhibit formation of wrinkles or bulging of materials at these portions. As a result, since the surfaces of the lead wires 11, 12, 13, 14 are flat, processes such as welding or attaching parts, such as a holder, to the lead wire 11, 12, 13, 14 can be performed in a stable manner.

Particularly, in a case where the shape of the orthogonal cross sections of the lead wires 11, 12, 13, 14 have a longer side in the direction Y as shown in FIG. 4B, problems such as wrinkling or bulging of the materials tend to occur when the lead wire 11, 12, 13, 14 are bent without being processed. Such problems can be inhibited by the process of narrowing the widths W in the direction Y.

As shown in FIG. 4C, in a case where the shape of the orthogonal cross sections at the A-bend portions 11A, 14A, the B-bend portions 11B, 14B, the C-bend portions 12C, 13C, and the D-bend portions 12D, 13D have a width W smaller than the thickness T as a result of the process of narrowing the width W in the direction Y, the aforementioned effect can be further enhanced. In addition, the operation of bending the lead wires at the recessed portions 15 is further facilitated.
(1C) When manufacturing the sensor 1, the process of narrowing the widths W in the direction Y at the A-bend portions 11A, 14A, the B-bend portions 11B, 14B, the C-bend portions 12C, 13C, and the D-bend portions 12D, 13D is the punching process. Thus, the process is easy.
(1D) In the punching process, the two adjacent lead wires are simultaneously punched at portions facing the counterpart lead wires respectively. Consequently, the load applied to the punch 17 from one of the two adjacent lead wires is opposite in direction to the load applied to the punch 17 from the other lead wire, and thus these loads cancel each other out. As a result, it is possible to inhibit a phenomenon in which the load applied to the punch 17 becomes biased, causing the punch 17 to move away from the lead wires 11, 12, 13, 14. It is also possible to inhibit a decrease in punching accuracy and thus a tendency for the lead wires 11, 12, 13, 14 to break.
(1E) As a different method for increasing the intervals between the lead wires, there is a method in which an additional component is attached to the unprocessed sensor 101. The additional component includes four lead wires having wide intervals between each other. Each of the four lead wires of the additional component is electrically conductive with a corresponding one of the lead wires 11, 12, 13, 14. The sensor 1 can be reduced in size compared with a case in which the additional component is attached to the unprocessed sensor 101.

### Other Embodiments

Although the embodiment of the present disclosure has been explained above, the present disclosure can be implemented in various modifications without being limited to the aforementioned embodiment.
(1) The number of the lead wires included in the sensor 1 may be five or more, and may be, for example, six, eight, or ten. In a case where the number of the lead wires is five or more, there is one or more additional lead wires between the lead wire 12 and the lead wire 13. The additional lead wire(s) may be bent in the same manner as the lead wires 11, 12, 13, 14, or may be left without being bent. The additional lead wire(s) may include the recessed portion 15 formed at a portion to be bent like in the lead wires 11, 12, 13, 14, or may include no recessed portions 15.
(2) The process of narrowing the widths W in the direction Y (for example, the punching process) does not have to be performed at a part of or all of the A-bend portions 11A, 14A, the B-bend portions 11B, 14B, the C-bend portions 12C, 13C, and the D-bend portions 12D, 13D. Even in this case, the aforementioned effect in (1A) is exerted.
(3) The punching process may be performed in a method different from the method in the first embodiment. For example, the recessed portion 15 may be formed inside or outside of each of the lead wires 11, 12, 13, 14. Alternatively, the recessed portion 15 may be formed on the side facing the direction Y or on the side facing a direction opposite to the direction Y in each of the lead wires 11, 12, 13, 14. Even in this case, the aforementioned effects in (1A) to (1C) are exerted.
(4) The process of narrowing the widths W in the direction Y at the A-bend portions 11A, 14A, the B-bend portions 11B, 14B, the C-bend portions 12C, 13C, and the D-bend portions 12D, 13D may be a process other than the punching process. For example, it may be a process of grinding a part of the lead wires 11, 12, 13, 14 or the like. Even in this case, the aforementioned effects in (1A) and (1B) are exerted.
(5) The sensor 1 may be a sensor other than the ABS sensor. The sensing element may be an element other than the magnetism detecting element. The number of the sensing elements installed inside the sensing portion 3 may be three or more.
(6) The method of bending the lead wires at the A-bend portions 11A, 14A, the B-bend portions 11B, 14B, the C-bend portions 12C, 13C, and the D-bend portions 12D, 13D may be different from the method described in the first embodiment.
(7) When viewed in the thickness directions of the lead wires 11, 12, 13, 14, the recessed portion 15 may have a shape other than an arc, for example, an elliptical arc, a V-shape, or a bracket-like shape.
(8) The recessed portions 15 at the A-bend portion 11A and the C-bend portion 12C may be smaller than, the same size as, or larger than the recessed portions 15 at the B-bend portion 11B and the D-bend portion 12D. The recessed portions 15 at the A-bend portion 14A and the C-bend portion 13C may be smaller than, the same size as, or larger than the recessed portions 15 at the B-bend portion 14B and the D-bend portion 13D.
(9) Functions of one element in each of the aforementioned embodiments may be distributed to two or more elements, and functions of two or more elements may be performed by one element. A part of the configurations of each of the aforementioned embodiments may be omitted. At least a part of the configurations of each of the aforementioned embodiments may be added to or may replace other configurations of the aforementioned embodiments.
(10) Other than the sensor 1 mentioned above, the present disclosure can be realized in various forms such as a system including the sensor 1 as an element, a method of processing a sensor, a method of bending a lead wire, and the like.

What is claimed is:

1. A method for adjusting lead wire intervals of a sensor, the sensor including a sensing portion, and four or more aligned lead wires extending in a common direction from the sensing portion, and the lead wire intervals being intervals between the four or more aligned lead wires,
the method comprising:
bending two outer-side lead wires situated at outermost positions among the four or more aligned lead wires outward at A-bend portions and inward at B-bend portions which are situated on a tip side of the outer-side lead wires relative to the A-bend portions; and
bending two inner-side lead wires situated on an inner side of the two outer-side lead wires among the four or more aligned lead wires outward at C-bend portions and inward at D-bend portions which are situated on the tip side of the inner-side lead wires relative to the C-bend portions.

2. The method according to claim 1, further comprising:
performing a process of narrowing width of at least one of the four or more aligned lead wires in a direction of alignment of the four or more aligned lead wires in at least one of the A-bend portions, the B-bend portions, the C-bend portions, or the D-bend portions before bending the four or more aligned lead wires.

3. The method according to claim 2,
wherein the process of narrowing the width is a process of punching a portion of the four or more aligned lead wires.

4. The method according to claim 3,
wherein, in each of two adjacent lead wires among the four or more aligned lead wires, a portion facing a counterpart lead wire is punched.

5. A sensor comprising:
a sensing portion, and
four or more aligned lead wires extending in a common direction from the sensing portion,
wherein two outer-side lead wires situated at outermost positions among the four or more aligned lead wires are bent outward at A-bend portions and inward at B-bend portions which are situated on a tip side of the outer-side lead wires relative to the A-bend portions; and
wherein two inner-side lead wires situated on an inner side of the two outer-side lead wires among the four or more aligned lead wires are bent outward at C-bend portions and inward at D-bend portions which are situated on the tip side of the inner-side lead wires relative to the C-bend portions.

6. The sensor according to claim 5,
wherein width of at least one of the four or more aligned lead wires in a direction of alignment of the four or more aligned lead wires in at least one of the A-bend portions, the B-bend portions, the C-bend portions, or the D-bend portions is narrower than surrounding areas.
